(19) United States
(12) Patent Application Publication
(10) Pub. No.: US 2014/0063354 A1
(43) Pub. Date: Mar. 6, 2014

(54) LCD DEVICE AND MOLD

(71) Applicants: Yanxue Zhang, Shenzhen (CN); Yuchun Hsiao, Shenzhen (CN)

(72) Inventors: Yanxue Zhang, Shenzhen (CN); Yuchun Hsiao, Shenzhen (CN)

(21) Appl. No.: 13/638,122

(22) PCT Filed: Sep. 12, 2012
(86) PCT No.: PCT/CN2012/081279

§ 371 Date: Sep. 28, 2012

(30) Foreign Application Priority Data
Sep. 4, 2012 (CN) 201210355686.7

(51) Int. Cl. H04N 3/14; B29C 33/00; G02F 1/1333

(52) U.S. Cl. 348/790; 349/58; 425/470; 348/E03.016

(57) ABSTRACT

The present disclosure provides a liquid crystal display (LCD) device and a mold. The LCD device includes an LCD module. The LCD module includes a front frame, a middle frame, a backplane, an LCD panel, and a backlight module, the front frame acts as a front shell of the LCD device, and the backplane acts as a back shell of the LCD device. The from ham is a separate structure and comprises a plurality of member units, and the member units are strip-shaped or L-shaped. In the present disclosure, the front shell and the back shell, as two main components, can be directly removed, thereby reducing component types.

### TECHNICAL FIELD

The present disclosure relates to the field of liquid crystal displays (LCDs), and more particularly to an LCD device and a mold.

### BACKGROUND

Liquid crystal display (LCD) technology is widely applied to various fields. LCDs for computers, LCD tablets, and LCD TV sets are the most common LCD devices, complete LCD device usually includes a from shell, an LCD module, and a back shell the front shell and the back shell are used for fixing the LCD module between the front shell and back shell, the front shell is further used for decorative appearances, and the back shell is further used for fixing the power board, the main hoard and the like. The LCD module usually includes a front frame, a middle frame, a backplane, an LCD panel, and a backlight module. The LCD panel is arranged between the front frame and the middle frame, and the backlight module is arranged between the middle frame and the backplane. In general, the LCD device and the LCD module are assembled in different factories, and the LCD device is assembled after the LCD module is assembled. Because there are complicated processes in multiple assemblies and multiple components of the LCD device, the components need to be mutually positioned and fixed, thereby wasting time and energy, requiring, improvement.

### SUMMARY

In view of the above-described problems, the aim of the present disclosure is to provide an liquid crystal display (LCD) device with the advantages of few components, simple structure and easy assembly, and a mold used for manufacturing a front frame and a middle frame.

A first technical scheme of the present disclosure is that: an LCD device comprises an LCD module. The LCD module comprises a front frame a middle frame, a backplane, an LCD panel, and a backlight module. The LCD panel is arranged between the front frame and the middle frame, and the backlight module is arranged between the middle frame and the backplane. The front frame is further acts as the front shell of the LCD device, and the backplane acts as the back shell of the LCD device. The front frame is a separate structure and comprises a plurality of member units, and the member units are strip-shaped. The from frame comprises four edge frames, and the four edge frames respectively constitute four member units. Both the front frame and the backplane are positioned inside the middle frame, and the front frame is fixed and connected to the backplane by a screw. The middle frame is clamped between the front frame and the backplane. The backplane is configured with a stud. The front frame is configured with a through hole, and the screw passes through the through hole and fixes and connects the front frame to the backplane. The middle frame is configured with a through hole to receive the screw and the stud. Both the front frame and the middle frame are made of a plastic material, and are injection molded in a same mold. The front frame and the middle frame are injection molded using the extremely cold and extremely hot process.

A second technical scheme of the present disclosure is that an LCD device comprises an LCD module. The LCD module comprises a front frame, a middle frame, a backplane, an LCD panel, and a backlight module. The LCD panel is arranged between the front frame and the middle frame, and the backlight module is arranged between the middle frame and the backplane. The front frame is further acts as the front shell of the LCD device, and the backplane acts as the back shell of the LCD device. The front frame is a separate structure and comprises a plurality of member units, and the member units are strip-shaped or L-shaped.

In one example, the front frame comprises four edge frames, and the four edge frames respectively constitute four member units. Because the front frame is divided into four strip-shaped edge frames, the mold size is greatly reduced. Thus, the mold development cost is reduced, and the injection molding cost is reduced.

In one example, the front frame comprises four edge frames. A first two of the four edge frames are connected to form one L-shaped member unit, and a second two edge frames are connected to form the other L-shaped member unit.

In one example, both the front frame and the backplane are positioned inside the middle frame. Thus, the outside of the middle frame becomes a smooth plane with good hand feeling holding.

In one example, the front frame is fixed and connected to the backplane by a screw, and the middle frame is clamped between the front frame and the backplane. By using the screw to connect the front frame, the backplane and the middle frame, the present disclosure has a simple structure and easy achievement.

In one example, the backplane is configured with a stud, the front frame is configured with a through hole, the screw passes through the through hole fixedly connects the front frame to the backplane with the stud. The middle frame is configured with a through hole to receive the screw and the stud. The screw is not easily visible to people because it is arranged on a back of the backplane.

In one example, both the front frame and the middle frame are made of plastic. material, and are injection molded in a same mold.

In one example, the front frame and the middle frame are injection molded using the extremely cold and extremely hot process. Thus, smooth and clean surface can be formed, thereby playing a role of decoration.

In one example, the LCD device is an LCD, LCD tablets or an LCD TV set.

A third technical scheme of the present disclosure is that: a mold for manufacturing a front frame and a middle frame, the front frame is a separate structure and comprises to plurality of member units, and the member units are strip-shaped or L-shaped. The mold comprises a plurality of member unit cavities and middle frame cavities. The member unit cavities are distributed around the periphery of the middle frame cavities.

Advantages of the present disclosure are summarized below: the LCD device of the present disclosure is designed using the integration idea without being configured with a front shell and a back shell, where the front frame of the LCD module is directly acts as the front shell, and the backplane of the LCD module acts as the back shell. The front shell and the back shell, as two main components, can be directly removed by moving one or more structures of the front shell onto the front frame and moving one or more structures of the back shell onto the backplane. Thus, the component types are reduced, the manufacturing cost is reduced, and the assembling process is simplified. Because the LCD module and the LCD device are assembled on the same production line, thickness and weight of the LCD device are reduced, and the LCD device can be made thinner and lighter. Because the front frame is divided into a plurality of member units, and the member units are strip-shaped or L-shaped, the size of the mold for manufacturing the front frame is significantly reduced. Moreover, by using a similar size characteristics of the member units of the front frame and the middle frame, the member unit cavities and the middle frame cavities are arranged in a same mold, thereby reducing the mold development cost, and reducing the injection molding cost.

### BRIEF DESCRIPTION OF FIGURES

FIG. 1 is a structural diagram of an LCD device of the present disclosure;

FIG. 2 is a schematic diagram of a separate structure of a first example of a front frame of present disclosure;

FIG. 3 is a structural diagram of a first example of a mold of the present disclosure;

FIG. 4 is a schematic diagram of a separate structure of a second example of a front frame of present disclosure; and

FIG. 5 is a structural diagram of a second example of a mold of the present disclosure.

### DETAILED DESCRIPTION

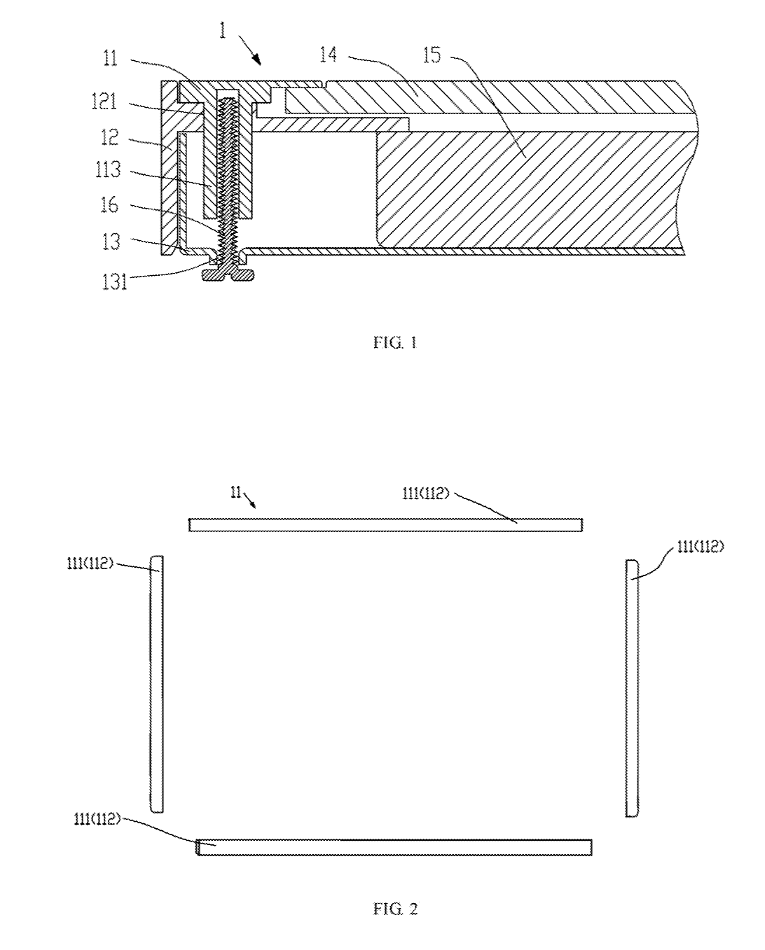

The present disclosure provides an LCD device, which can be a liquid crystal display (LCD) for computer, LCD tablets, or an LCD TV set. FIG. 1 and FIG. 2 show an example of the LCD device of the present disclosure. The LCD device comprises an LCD module 1. The LCD module 1 comprises a front frame 11, a middle frame 12, a backplane 13, an LCD panel 14, and a backlight module 15. The LED panel 14 is arranged between the front frame 11 and the middle frame 12, and the backlight module 15 is arranged between the middle frame 12 and the backplane 13. The front frame 11 acts as a front shell of the LCD device, and the backplane 13 acts as a back shell of the LCD device. The front frame 11 is a separate structure, and comprises a plurality of member units 111. There are four member units 111 m the example, and the member units 111 are strip-shaped.

The LCD device of the present disclosure is designed using integration without being configured with a front shell and a back shell, where the front frame 11 of the LCD module 1 directly acts as the front shell, and the backplane 13 of the LCD module 1 acts as the back shell. The front shell and the back shell, as two main components, can be directly removed, by moving one or more structures of the front shell onto the front frame 11 and moving one or more structures of the back shell onto the backplane 13. Thus, the component types are reduced, the manufacturing cost is reduced, and the assembling process is simplified. Because the LCD module 1 and the LCD device are assembled on the same production line, thickness of the LCD device is reduced, and the LCD device can be made thinner and lighter. In addition, because the front frame in the prior art is thin and narrow, but has a large plane size, if it is manufactured by a typical manufacturing mold, manufacturing cost is very high because the mold has a large size. As shown in FIG. 2, the front frame of the present disclosure is a separate structure, and comprises four edge frames 112. The four edge frames 112 respectively constitute four member units 111. Because the front frame 11 is divided into four strip-shaped member units 111, the mold size is greatly reduced, the mold development cost is reduced, and the injection molding cost is reduced.

In the example, the front frame 11 is fixed and connected to the backplane 13 by a screw 16, the front frame 11 is configured with a stud 113, the backplane 13 is configured with a through hole 131, and the screw 16 passes through the through hole 131 and connects with the stud 113, thereby fixing and connecting the front frame 11 to the backplane 13. The middle frame 12 is configured with a through hole 121 to receive the screw 16 and the stud 113, and the middle frame 12 is clamped between the front frame 11 and the backplane 13. By using the screw to connect the front frame, the backplane and the middle frame, the present disclosure has a simple structure and easy achievement. The screw 16 is not easily visible to people because it is arranged on a back of the backplane 13.

In the example, both outside sizes of the front frame 11 and the backplane 13 are less than outside sizes of the middle frame 12. The front frame 11 is positioned inside the middle frame 12, and the backplane 13 is also positioned inside the middle frame 12. Thus, the outside of the middle frame 12 becomes a smooth plane, feels good in the hand when held, and becomes more beautiful.

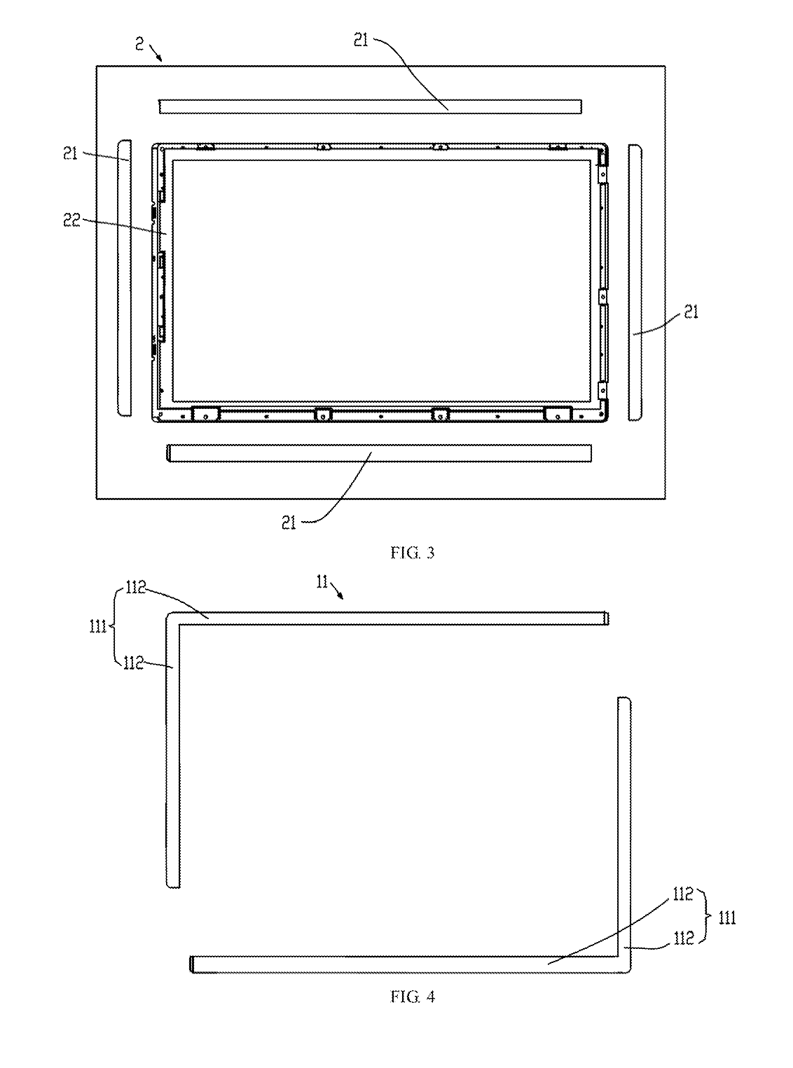

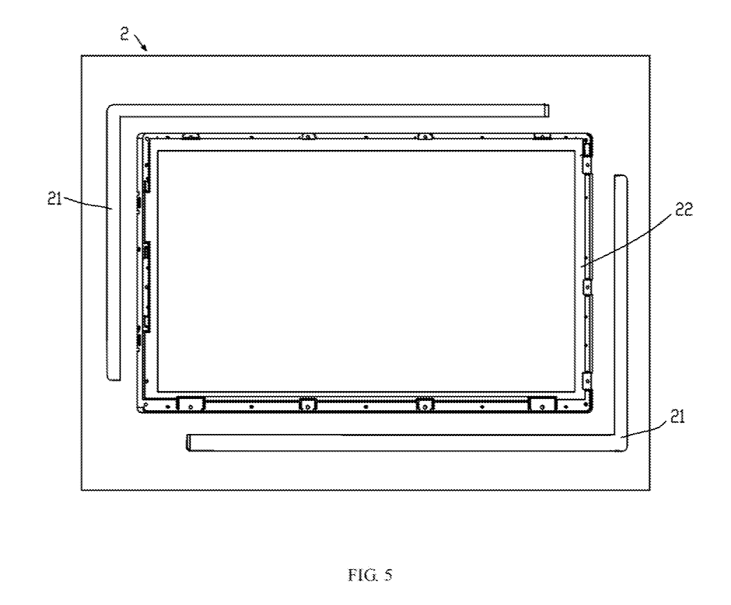

Both the front frame 11 and the middle frame 12 are made of a plastic material, and are injection molded in a same mold 2. As shown in FIG. 3, the mold 2 comprises member unit cavities 21 and middle frame cavities 22. The member unit cavities 21 are distributed around a periphery of the middle frame cavities 22. The mold 2 can mold the four member units of the front frame and the middle frame simultaneously. Because the present disclosure requires the middle frame to have a higher strength, the middle frame is generally an integrated structure. Namely, the middle frame is a one-step mold that is molded by the mold where the mold size of the middle frame is large. By using similar size characteristics of the member units of the front frame and the middle frame in the present disclosure, the four member unit cavities 21 are distributed around the periphery of the middle frame cavities 22. Because width of the member unit cavities 21 is narrow, the member unit cavities 21 may be contained in the mold 2 if the size of the mold 2 is slightly increased, thereby significantly reducing cost of the mold 2. In addition, the front frame and the middle frame of the present disclosure are injection molded by using an extremely cold and extremely hot process. Thus, smooth and clean surface can be formed, thereby playing a decorative role.

The present disclosure is described in detail in accordance with the above contents with the specific preferred examples. However, this present disclosure is not limited to the specific examples. For the ordinary technical personnel, of the technical field of the present disclosure, on the premise of keeping the conception of the present disclosure, the technical personnel can also make simple deductions or replacements, and all of which should be considered to belong to the protection scope of the present disclosure.

1. A liquid crystal display (LCD) device, comprising:
an LCD module, wherein the LCD module comprises a front frame, a middle frame, a backplane, an LCD panel, and a backlight module; wherein the LCD panel is arranged between the front frame and the middle frame, and the backlight module is arranged between the middle frame and the backplane;
wherein the front frame acts as a front shell of the LCD device, and the backplane acts as a back shell of the LCD device;
wherein the front frame is a separate structure and comprises a plurality of member units, and wherein the member units are strip-shaped; the front frame comprises four edge frames, and the four edge frames respectively constitute four member units;
wherein both the front frame and the backplane are positioned inside the middle frame, the front frame is fixed and connected to the backplane by a screw, and the middle frame is clamped between the front frame and the backplane;
wherein the front frame is configured with a stud, the backplane is configured with a first through hole, the screw passes through the first through hole and fixes and connects with the front frame to the backplane, and the middle frame is configured with a second through hole to receive the screw and the stud; and
wherein both the front frame and the middle frame are made of a plastic material.

2. A liquid crystal display (LCD) device, comprising:
an LCD module, wherein the LCD module comprises a front frame, a middle frame, a backplane, an LCD panel, and a backlight module; wherein the LCD panel is arranged between the front frame and the middle frame, and the backlight module is arranged between the middle frame and the backplane;
wherein the front frame acts as a front shell of the LCD device, and the backplane acts as a hack shell of the LCD device; and
wherein the front frame is a separate structure and comprises a plurality of member units, and the member units are strip-shaped or L-shaped.

3. The LCD device of claim 2, wherein the front frame comprises four edge frames, and the four edge frames respectively constitute four member units.

4. The LCD device of claim 2, wherein the front frame comprises four edge frames; a first two of the four edge frames are connected to form one L-shaped member unit, and a second two edge frames are connected to form the other L-shaped member unit.

5. The LCD device of claim 2, wherein both the front frame and the backplane are positioned inside the middle frame.

6. The LCD device of claim 2, wherein the front frame is fixed and connected to the backplane by a screw, and the middle frame is clamped between the from frame and the backplane.

7. The LCD device of claim 6, wherein the front frame is configured with a stud, the backplane is configured with a first through hole, the screw passes through the first through hole and fixedly connects the front frame to the backplane with the stud; the middle frame is configured with a second through hole to receive the screw and the stud.

8. The LCD device of claim 2, wherein both the front frame and the middle frame are made of plastic material.

9. The LCD device of claim 8, wherein the front frame and the middle frame are injection molded using the extremely cold and extremely hot process.

10. The LCD device of claim 2, wherein the LCD device is an LCD, LCD tablet, or an LCD TV set.

11. A mold for manufacturing a front frame and a middle frame,
wherein the front frame is a separate structure and comprises a plurality of member units, and wherein the member units are strip-shaped or L-shaped; the mold comprises a plurality of member unit cavities and middle frame cavities, and the member unit cavities are distributed around a periphery of the middle frame cavities.
